(19) United States
(12) Patent Application Publication
(10) Pub. No.: US 2008/0117055 A1
(43) Pub. Date: May 22, 2008

(54) Light activated radio frequency identification conveyance system

(75) Inventors: Robert E. Blake, Woodbury Heights, NJ (US); Robert W. Perry, Sicklerville, NJ (US); Steven D. Essinger, Philadelphia, PA (US)

Correspondence Address: Glenn A. Cavanaugh;METROLOGIC INSTRUMENTS, INC, 90 COLES ROAD, BLACKWOOD, NJ, 08012, US

(73) Assignee: Metrologic Instruments, Inc.

(21) Appl. No.: 11/602,448

(22) Filed: Nov. 20, 2006

(51) Int. Cl. G08B 13/14

(52) U.S. Cl. 340/572.7

(57) ABSTRACT

A radio frequency identification (“RFID”) method, computer-readable medium, apparatus, and system are provided. In one embodiment, the method uses at least one light sensor to detect an item and to provide peripheral information of the item. Thereafter, the method determines the item's location, on a conveyor, from the peripheral information and a speed of the conveyor; and switches to an RFID reader antenna in a plurality of RFID reader antennas in accordance with the item location. In other embodiments, the apparatus, system, and computer-readable medium are also provided which perform similar features recited by the above method.

### BACKGROUND OF THE INVENTION

1. Field of the Invention

Embodiments of the present invention generally relate to conveyance systems and more particularly, to light activated switching to an antenna in accordance with a position of an item on a conveyor and/or dimensional information of the item.

2. Description of the Related Art

Movable conveyance systems (e.g., conveyor belts) are often utilized to efficiently move products. Often systems are utilized, with the conveyor systems, to monitor the movement of the products.

A radio frequency identification (“RFID”) system typically employs at least two components, a “transponder” (also known as a “tag”), which is attached to the physical item to be identified, and a “reader,” which sends an electromagnetic signal to the transponder and then detects a response. Typically, the reader emits an RF signal, which is received by the transponder, after the transponder comes within an appropriate range. In response, the transponder sends its information via a modulated RF signal back to the reader. The reader detects this modulated signal, and can identify the transponder by decoding the modulated signal. After identifying the transponder, the reader can either store the decoded information or transmit the decoded signal to a computer.

As products move along the conveyor, an RFID antenna produces an RF field however; the RF field may not be optimized for efficient communication with the transponder(s). Therefore, there is a great need in the art for an improved conveyance system that avoids the shortcomings and drawbacks of prior art conveyance systems and methodologies.

### SUMMARY OF THE INVENTION

These and other deficiencies of the prior art are addressed by the present invention, which generally relates to scanning systems and more particularly, to switching to a radio frequency identification (“RFID”) antenna in accordance with sensory information provided by a light sensor. An RFID method, computer-readable medium, apparatus, and system are provided. In one embodiment, the method uses at least one light sensor to detect an item and to provide peripheral information of the item. Thereafter, the method determines the item's location, on a conveyor, from the peripheral information and a speed of the conveyor; and switches to an RFID reader antenna in a plurality of RFID reader antennas in accordance with the item location. In other embodiments, the apparatus, system, and computer-readable medium are also provided which perform similar features recited by the above method.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only embodiments of this invention and are therefore not to be considered limiting of its scope, for the invention may admit to other equally effective embodiments.

FIG. 1 depicts a perspective view of an exemplary conveyor system used in accordance with aspects of this disclosure;

FIG. 2 depicts another perspective view of the exemplary conveyor system used in accordance with aspects of this disclosure;

FIG. 3 depicts a perspective view of another exemplary conveyor system used in accordance with aspects of this disclosure;

FIG. 4 depicts a block diagram of an exemplary reader/transponder pair 200 in accordance with aspects of this disclosure;

FIG. 5 depicts a high-level block diagram of an exemplary system 500 for performing aspects of this disclosure;

FIG. 6 depicts an embodiment of a method in accordance with aspects of the disclosure; and

FIG. 7 depicts a high-level block diagram of a computer architecture for performing aspects of this disclosure.

To facilitate understanding, identical reference numerals have been used, wherever possible, to designate identical elements that are common to the figures.

### DETAILED DESCRIPTION

In the following description, numerous specific details are set forth to provide a more thorough understanding of the invention. As will be apparent to those skilled in the art, however, various changes using different configurations may be made without departing from the scope of the invention. In other instances, well-known features have not been described in order to avoid obscuring the invention. Thus, the invention is not considered limited to the particular illustrative embodiments shown in the specification and all such alternate embodiments are intended to be included in the scope of this invention.

The invention may be used with various types of conveyor systems. For example, the invention may be utilized with conveyors that incorporate symbol (e.g., bar code) scanning systems (e.g., omni-directional or non-omni-directional scanners); or by retrofitting conveyor systems, which do not have symbol scanning systems. For illustrative purposes only, the invention is described with respect to an omni-directional scanner; and with respect to a conveyor system not having a scanner however, those depictions are not intended in any way to limit the scope of the invention.

Further, for illustrative purposes, the invention has been described with respect to an omni-directional scanner produced by Metrologic, Instruments, Inc. of Blackwood N.J. However, it is appreciated that the invention is not limited to the illustrative scanner disclosed herein. This document incorporates by reference all of the material disclosed within commonly owned and assigned U.S. Pat. No. 6,971,580 issued Dec. 6, 2005 and entitled AUTOMATED METHOD OF AND SYSTEM FOR DIMENSIONING OBJECTS OVER A CONVEYOR BELT STRUCTURE BY APPLYING CONTOURING TRACING, VERTICE DETECTION, CORNER POINT DETECTION, AND CORNER POINT REDUCTION METHODS TO TWO-DIMENSIONAL RANGE DATA MAPS OF THE SPACE ABOVE THE CONVEYOR BELT CAPTURED BY AN AMPLITUDE MODULATED LASER SCANNING BEAM; and commonly owned and assigned U.S. Pat. No. 6,959,868 issued Nov. 1, 2005 and entitled TUNNEL-BASED METHOD OF AND SYSTEM FOR IDENTIFYING TRANSPORTED PACKAGES EMPLOYING THE TRANSMISSION OF PACKAGE DIMENSION DATA OVER A DATA COMMUNICATIONS NETWORK AND THE TRANSFORMATION OF PACKAGE DIMENSION DATA AT LINEAR IMAGING SUBSYSTEMS IN SAID TUNNEL-BASED SYSTEM SO AS TO ENABLE THE CONTROL OF AUTO ZOOM/FOCUS CAMERA MODULES THEREWITHIN DURING LINEAR IMAGING OPERATIONS, as if being set forth in its entirety herein.

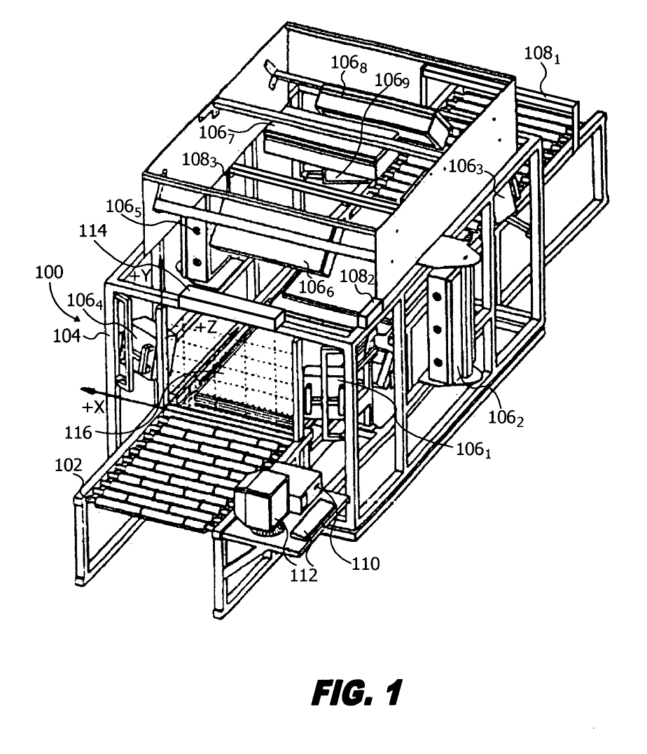

FIG. 1 depicts a perspective view of an exemplary conveyor system 100 in accordance with an embodiment of the invention. The exemplary scanner system 100 includes a conveyor 102; a scanner support framework 104; scanners 106₁, 106₂, 106₃, 106₄, 106₅, and 106₆ (collectively scanners 106) (e.g., holographic scanning subsystems); a graphical user interface 112 (illustratively depicted as a combination of a monitor and keyboard); a computer-processing unit 110; light arrays 114₁ and 114₂ (collectively light arrays 114); and RFID antennas 108₁, 108₂, 108ₙ₋₁, and 108ₙ (collectively RFID antennas 108).

Although the invention is described using holographic imagers 106 (e.g., scanners) it is appreciated that other types of imaging systems may be used in accordance with the invention. Some exemplary imaging systems that may be used are, but not limited to, camera imaging systems, non-holographic scanning systems, and counter-top scanning systems.

The support frame 104 is positioned over a portion of the conveyor 102 to form a cavity 116. Items on the conveyor 102, which pass through the cavity 116, are interrogated and/or optically scanned. The volume formed by the cavity 116 is herein referred to as an “interrogation zone 116.”

For illustrative purposes “X,” “Y,” and “Z” axes are also shown in FIG. 1. Illustratively, the “Y” axis is parallel to the longitudinal axis of the conveyor 102; the “X” axis is transverse to the longitudinal axis of the conveyor and substantially perpendicular to the “Y” axis; and the “Z” axis is substantially perpendicular to the “X” and “Y” axes. An item, when placed on the conveyor 102, moves along the conveyor 102, parallel to the “Y” axis, towards the interrogation zone 116.

Each light array 114 (e.g., light array 114₁) contains at least one light sensor. Light sensors in a respective light array 114₁ can be juxtaposed (i.e., positioned in a line) with other light sensors in light array 114₁. Various factors are considered when designing a light array. For example, the distance between the light sensors and the number of light sensors in the light array 114 will help determine the maximum peripheral coverage area (and the degree of accuracy regarding the periphery). This can be used to determine the RFID antennae configuration, the time that the RFID is on, and the amount of power used to interrogate. Illustratively, light sensors can be used which have about a 10 degree coverage lobe.

The sensors/emitters in light arrays 114 (and their orientation) are calibrated to the conveyor 102. For example, calibration can include, but not limited to, measuring and recording the distance between the light arrays 114 and the conveyor 102. When an item is placed on the conveyor 102 (and prior to the item's entrance into the interrogation zone 116), light sensors in the light arrays 114 sense the presence of and peripheral information (e.g., height, width, and/or length) of the item on the conveyor 102. As the item passes across the light arrays 114, sensory information (i.e., the presence of the item and the item's peripheral dimensions) is transmitted towards the computer-processing unit 110.

Light arrays 114 illustratively operate in the visible light spectrum (e.g., from about 380 nano-meters to about 780 nano-meters) and are illustratively depicted as a light curtain. For clarity, the light arrays 114 are described as sensors, which operate in the visible light spectrum. However, it is appreciated that the light arrays 114 may incorporate light sensors operating at a different frequency range in accordance with the invention. For example, light arrays 114 can be sensors that emit light visible to the human eye, in various embodiments; or light not visible to the human eye (e.g., infrared), in other embodiments. In addition, light arrays 114, in yet other embodiments can be a combination of light visible to the human eye and light not visible to the human eye.

The arrays 114 can be incorporated into many types of conveyor systems. The arrays 114 are fixed with respect to the conveyor 102 and to the RFID antennas 108. After the arrays 114 have been added to the conveyor 102, the arrays 114 are calibrated to the conveyor 102. With proper positioning and calibration, the arrays 114 can provide information used to determine the dimensions (e.g., length, width, and/or height) of the item (e.g., a package). For example, light array 114 can be positioned above and transversely across the conveyor 102; and/or substantially perpendicular to the conveyor 102.

The microprocessor 406 processes the received information (e.g., regarding the dimensions of the item and the speed of conveyor 102) to track the item (e.g., as it passes through the interrogation zone 116). Thereafter, the microprocessor 406 determines which antenna in the reader antenna array 414 is optimally suited for communication (i.e., transmission and/or reception) of radio frequency information.

In addition, the light arrays 114 can also provide a counter for the items on the conveyor 102. For example, when the light arrays 114 detect an item, the computer-processing unit 110 can check whether there was a scan read. If there is no scan read then the item can be set aside and checked; or resent through scanner. Exemplary ways of setting the items aside include, but are not limited to, diversion of the items into a bin and periodically checking the bin; and/or putting the items back on the conveyor for rechecking immediately after an indication that the item was not scanned. If a failed scan read process occurs enough times (decided by the user) then the items can be further checked to see if there is a label; or can be hand scanned after failure by the conveyor scanner.

It is also appreciated that in various embodiments of the invention, the item's dimensions may be transmitted to the computer-processing unit 110 (e.g., input via the graphical user interface 112); or stored in memory prior to an item being placed on conveyor 102.

The speed of the conveyor 102 is transmitted towards the computer-processing unit 110. For example, a tachometer (not shown) can regulate and/or monitor the speed of the conveyor 102. The-computer processing unit 110 uses the item's dimensional information and speed of the conveyor 102 (i.e., the speed of the item) to determine the position of the item during the time that the item is on the conveyor 102.

The computer-processing unit 110 has, stored in memory, the operating specifications and locations of each of the RFID antennas 108. Each of the RFID antennas 108 can be of the same type or comprising multiple types of antennas. For example, RFID antenna 108₁ can be a loop antennae, RFID antenna 108₂ can be a Hyedio Yagi antennae, and RFID antenna 108₃ can be a circular antenna. Other exemplary antennas adaptable for use with the present disclosure are dipole antennas and patch antennas. In addition to determining the position of the item on the conveyor 102, the computer-processing unit 110 determines which antenna 108 is the optimal RFID antenna 108 for communication with an RFID transponder (discussed in greater detail below). After a determination of the optimal RFID antenna 108, the computer processing unit 110 transmits an instruction to an antenna switch (discussed in greater detail below) to switch to the optimal RFID antenna 108.

Although the scanner system 100 is depicted as having six scanner subsystems 106 (scanners 106₁-106₆) that depiction is for illustrative purposes only. The scanner subsystems 106 are strategically positioned on support frame 104 to scan items in the interrogation zone 116. For example, individual scanners can be positioned in the corners, top, and sides (and optionally the front and back) of the support frame 104 to scan the interrogation zone 116. Illustratively, the scanners 106 can be three dimensional triple-disc holographic scanners having multiple focal points.

In addition, the antennas 108 are tuned to the height of the antennas 108 in relation to the conveyor and interrogation path. This information is used to activate and optimize the RF field. The antenna configuration would be optimized for the size of the box and the location of the tag. The RF field is on all the time but in stand-by mode. One antenna 108 would be the default antenna (one used most often) unless the system indicated that another antennae would be better suited.

In other embodiments, the antennas 108 are hardware activated by the light arrays 114. For example, a sensor (or combination of sensors) in light array 114₁ (or combination of light arrays 114ₙ) activates a specific antenna.

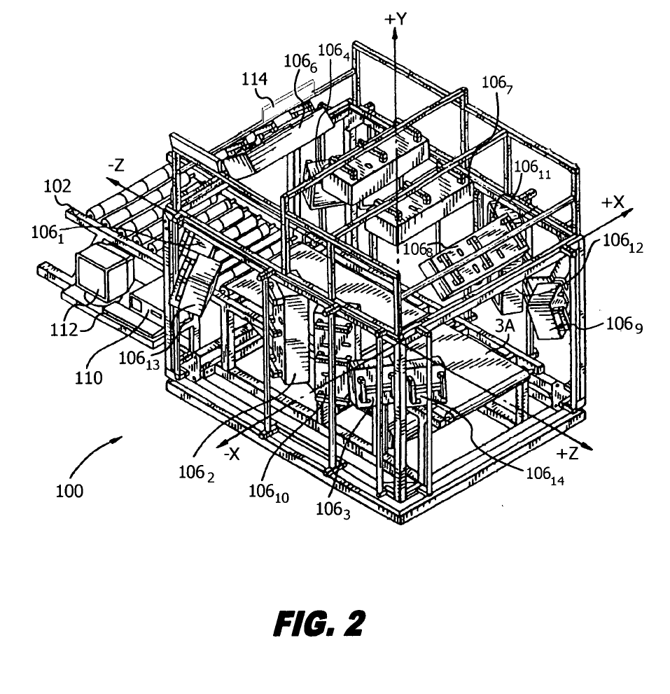

FIG. 2 depicts another perspective view of the exemplary conveyor system 100 in accordance with aspects of this disclosure. Some of the elements depicted in FIG. 2 have already been described in FIG. 1. For brevity, those elements having already been described in FIG. 1 will not be described again in FIG. 2. In addition, to the previously described elements, FIG. 2 also depicts additional scanner subsystems 106₇, 106₈, 106₉, 106₁₀, 106₁₁, 106₁₂, 106₁₃, and 106₁₄ (scanners 106₁-106₁₄ are collectively known as scanners 106). The inclusion of the sixteen scanner subsystems 106 in conveyor system 100 is optional. In various embodiments, the conveyor system 100 utilizes an item dimensioning module 114, a RFID transponder/reader pair, and a plurality of reader antennas.

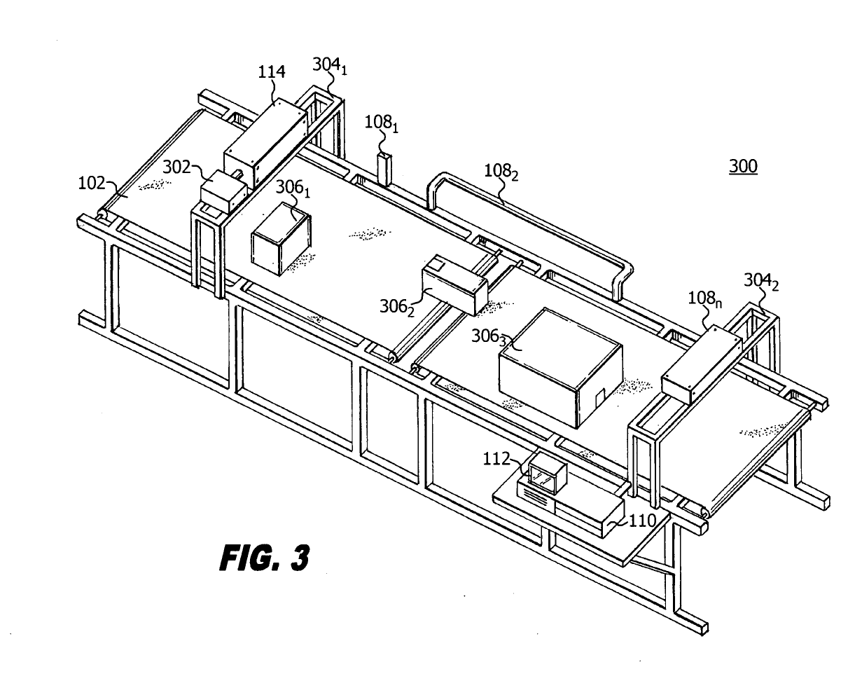

FIG. 3 depicts a perspective view of another exemplary conveyor system 300 used in accordance with aspects of this disclosure. The conveyor system 300 includes a conveyor 102; supports 304₁ and 304₂ (collectively supports 304); RFID reader antennas 108₁, 108₂, . . . 108ₙ (collectively antennas 108); light array 114₁, light array 114₂, and light array 114₃ (collectively light arrays 114); GUI 112; and computer processing unit 110.

The embodiments of the invention may be incorporated into various types of conveyors. For example, conveyor 102 can be retrofitted to include aspects of the invention. Specifically, supports 304 are mounted above conveyor 102. Support 304₁ has mounted thereon light arrays 114. When an item(s) 306₁, 306₂ and/or 306₃ (collectively item 306) is placed on conveyor 102, the item 306 is detected by the array 114. The operation of the light arrays 114, GUI 112, computer processing unit 110 and RFID reader antennas 108 have already been described in FIGS. 1 and 2. For brevity, an explanation of those elements already described is not repeated.

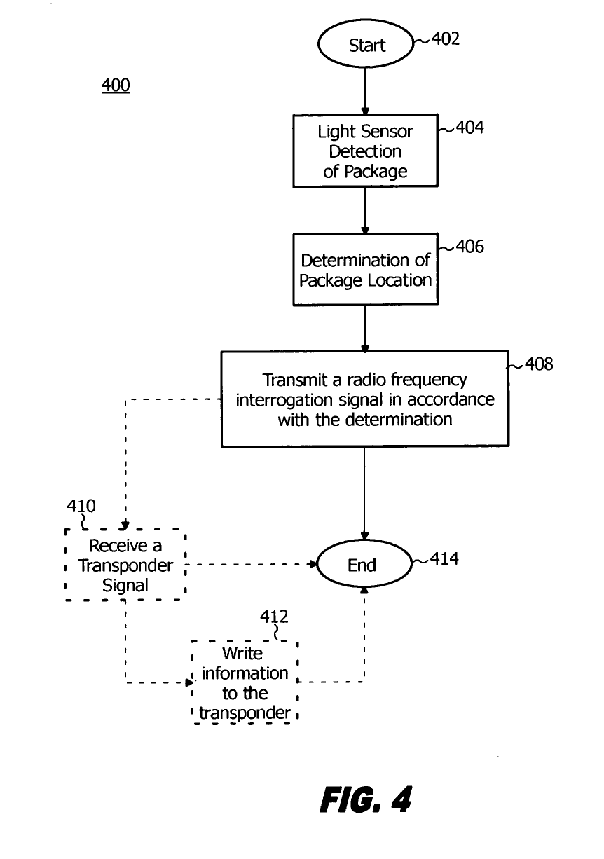

FIG. 4 depicts an embodiment of an antenna switching method 400 in accordance with aspects of the disclosure. The method 400 begins at step 402 and proceeds to step 404. At step 404, an item (e.g., a package) enters the range of a light sensor(s) (e.g., light arrays 114) and the sensor(s) detect(s) the presence of the item on a conveyor (e.g., conveyor 102). The light array 114, depending on the number of light sensors and their orientation, provides peripheral information accordingly. For example, light sensors traverse to and above the conveyor 102 can provide peripheral information regarding the length and width of the item; and light sensors positioned substantially perpendicular to the longitudinal axis of the conveyor 102 can provide peripheral information regarding the length and height of the item. Thereafter, in one embodiment, the method 400 proceeds to step 406.

In various embodiments, the method 400 proceeds from step 404 to step 406. In these embodiments, light array(s) 114 are hardwired to RFID antenna(s) 108.

At step 406, the method 400 uses the peripheral information (e.g., height, width, and/or length) of the item and the speed of the conveyor (i.e., the speed of the item) to determine the location of the item (e.g., a package). The item may be tracked on the conveyor 102 at any time after the initial position of the item on the conveyor 102 is determined. In various embodiments, the peripheral information of the item can be provided by a user or gathered by the light sensor(s).

Strategically positioned near the conveyor is a plurality of RFID reader antennas 108. The processing unit 110 also has stored in memory the characteristics (and positions with respect to the conveyor) of each of the RFID reader antennas (e.g., interrogation range, operating frequency range, and power consumption). The processing unit uses the peripheral information of the item and position of the item on the conveyor; and the characteristics and positions of the RFID reader antennas to determine which antenna is the best antenna to communicate with a transponder located on the item. After the processing unit 110 determines the best RFID reader antenna to communicate with the transponder, the method 400 proceeds to step 408.

At step 408, the processing unit 110 transmits an instruction to switch to the best RFID reader antenna and an interrogation signal to the transponder. In some instances, the current RFID reader antenna (or default RFID reader antenna) is the best RFID reader antenna to communicate with the transponder. In these instances there is no need for the processing unit to switch to another RFID reader antenna. As the item moves along the conveyor 102 the reader antenna used to communicate RF information with the transponder may change to a different reader antenna. For example, when the item initially enters the interrogation zone 116, reader antenna 108₁, may have been selected as the most suitable reader antenna in the reader antenna array 108 to communicate with the transponder. As the item is transported along the conveyor 102 a different reader antenna in the reader antenna array 108 may be better suited to communicate RF with the transponder. If a microprocessor (described in greater detail below) determines that another reader antenna in the reader antenna array 108 then the microprocessor may transmit instructions to the multiplexer (described in greater detail below) to switch from reader antenna 108₁ to another reader antenna (e.g., reader antenna 108₂).

There are instances when there is no transponder located on the item. In these instances the method 400, after transmission of the interrogation signal, proceeds to and ends and step 414.

Some embodiments of the method 400 include optional steps 410 and 412. For example, after transmission of the interrogation signal (i.e., after step 408), the method 400 optionally proceeds to step 410. At step 410, the RFID reader receives a signal from the transponder. The signal from the transponder contains information stored in the transponder. After reception of the transponder signal the method 400, in various embodiments, proceeds to and ends at step 414.

In yet other embodiments, the method 400 proceeds to step 412 after step 410. For example, there are instances when transponders are used that allow an RFID reader to write information to the transponder. At step 412 the reader transmits information to the transponder for storage on the transponder's memory. After step 412, the method 400 proceeds to and ends at step 414.

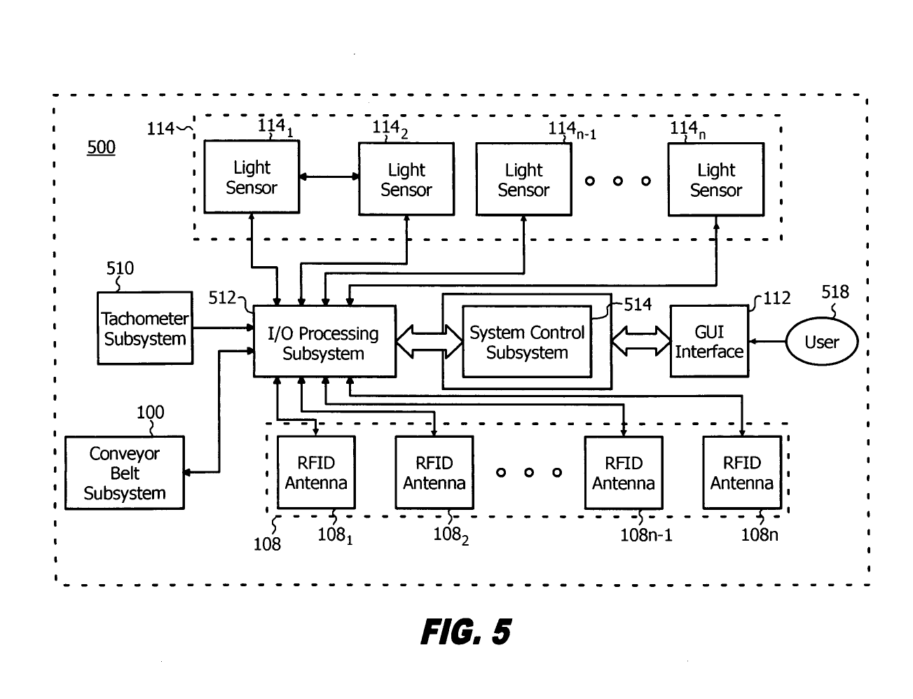

FIG. 5 is a high level block diagram of an exemplary system 500 for performing aspects of this disclosure. The system 500 includes light array subsystem 502, a tachometer subsystem 510, an I/O processing subsystem 512, an RFID antenna subsystem 108, a conveyor subsystem 100, a system control subsystem 514, a graphical user interface (“GUI”) subsystem 112, and a user 518 (optional).

The I/O processing subsystem 512 transmits information to and from the other subsystems depicted in FIG. 5. Communication between the I/O subsystem and the GUI 112 is provided by the system control subsystem 514. The system control subsystem 514 controls the other subsystems depicted in FIG. 5. The user 518 is able to view the status of the subsystems depicted in FIG. 5 and to enter instructions via the GUI 112.

In one embodiment, the item movement subsystem 502 includes a package velocity/length measurement subsystem 508, a package height/width profiling subsystem 506, and a package in-tunnel indication subsystem 504. When an item is placed on the moving conveyor 102 the package velocity/length measurement subsystem 508 measures the velocity and length of the item on the conveyor 102; the package height/width profiling subsystem 506 measures the height and width of the item; and the package in-tunnel indication subsystem 504 provides information regarding whether the item is in the tunnel. When the item has passed through and outside the tunnel the package out-of-tunnel subsystem 510 transmits information towards the I/O processing subsystem 512.

The I/O subsystem 512 transmits information from the item movement subsystem 502 to the system control subsystem 514 for processing and, when necessary receives information from the system control subsystem 514 for transmission towards the RFID antenna subsystem 516.

In various embodiments, the reader 402 is incorporated into the system control subsystem 514. In yet other embodiments, the reader 402 is a “standalone” unit coupled to the system control subsystem 514 and RFID antenna subsystem 516.

The RFID antenna subsystem 516 illustratively includes RFID antennas 108₁, 108₂, 108ₙ₋₁, and 108ₙ (collectively RFID antennas 108). It is appreciated that the RFID antenna subsystem 516 includes the same type of RFID antennas or alternatively different types of antennas.

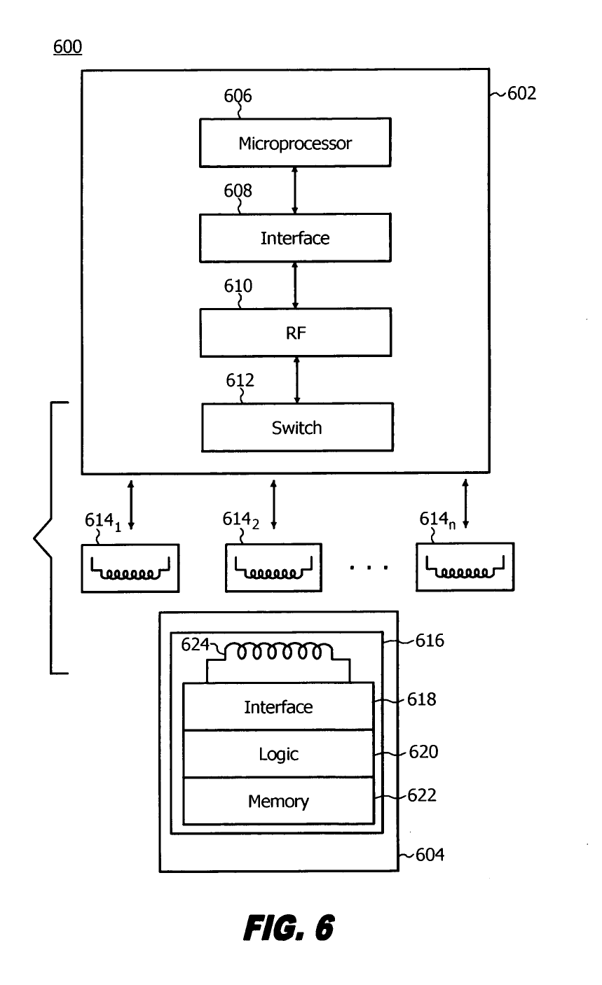

FIG. 6 is a block diagram of an exemplary reader/transponder pair 600 utilized in accordance with an embodiment of the invention. Generally, the reader/transponder pair 600 includes a reader 602 and a transponder 604 (also known as a “tag”).

The reader 602 includes a microprocessor 606; an interface 608; a radio frequency module 610 (and modulator (not shown)); a multiplexer 612; and reader antenna 614₁, reader antenna 614₂, and reader antenna 614ₙ (collectively reader antenna array 614). In various embodiments, a portion (i.e., the microprocessor 606, the interface 608, the radio frequency module 610, and/or the multiplexer 612) of the reader 602 can be inside the computer-processing unit 110 while the reader antenna array 614 is outside of the computer-processing unit 110.

The microprocessor 606 processes information regarding the dimensions of the item and the speed of conveyor 102 to track the item (e.g., as it passes through the interrogation zone 116). Thereafter, the microprocessor 606 determines which antenna in the reader antenna array 614 for transmission and/or reception of radio frequency signals (“RF signals”) to and from the transponder 604. The microprocessor 606 transmits a switching signal to the multiplexer 612 so that the multiplexer 612 will switch to an antenna in the reader antenna array 614.

The microprocessor 606 transmits information towards the interface 608 in accordance with the determination (e.g., which RFID reader antenna in the antenna array 614 to switch to).

The interface 608 translates information between the microprocessor 606 and the RF modulator 610. The RF modulator 610 transmits an RF signal to an appropriate antenna, through the multiplexer 612, in the reader antenna array 614.

Each reader antenna in the reader antenna array 614 can have the same frequency range; or operate a different frequency range than other reader antennas in the reader antenna array 614. Further, any antenna in the reader antenna array can be configured and designed to operate in the Low Frequency (“LF”), High Frequency (“HF”), Ultra-High Frequency (“UHF”), or Microwave Frequency. In addition, it is also appreciated that the reader antenna array 614 can utilize the same type of antennas or different types of antennas. Although FIG. 6 depicts the reader antenna array 614 as having three reader antennas that depiction is for illustrative purposes only. It is appreciated that more or less reader antennas can be included in the reader antenna array 614.

Various types of transponders 604 can be used in accordance with the invention (i.e., passive, semi-passive, or active). For illustrative purposes only, transponder 604 is described as a passive transponder. The transponder 604 includes a transponder antenna 624, a transponder interface 618, transponder logic circuitry 620, and memory 622.

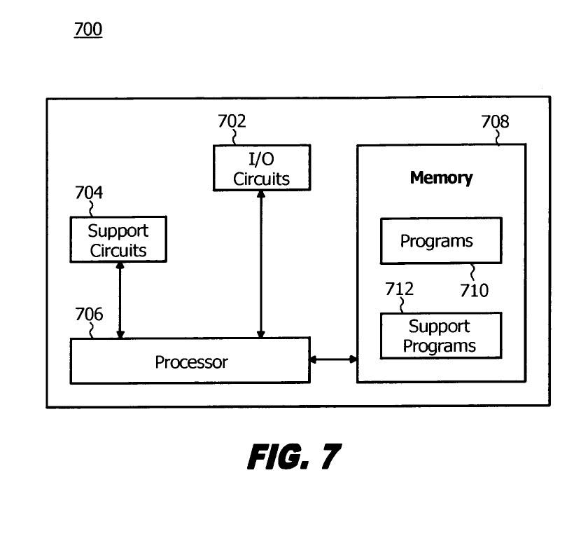

FIG. 7 depicts a high level block diagram of an embodiment of a controller 700, as part of electronic circuitry, suitable for use in providing a scan mode indicator (e.g., an audible signal) in accordance with a selected operation mode. The controller 700 of FIG. 7 comprises a processor 706 as well as a memory 708 for storing control programs 710 (e.g., antenna switching programs (e.g., for performing the method 400)), support programs 712, and the like. Although FIG. 7 is depicted as including an antenna switching system it is appreciated that controller 700 can include, in alternative embodiments, instructions for performing method 600. The processor 706 cooperates with conventional support circuitry 704 such as power supplies, clock circuits, cache memory and the like as well as circuits that assist in executing the software routines stored in the memory 708. As such, it is contemplated that some of the process steps discussed herein as software processes may be implemented within hardware, for example, as circuitry that cooperates with the processor 706 to perform various steps. The controller 700 also contains input-output circuitry 702 that forms an interface between the various functional elements communicating with the controller 700. For example, in various embodiments, the controller 700 also communicates with a data transmission subsystem for transmission of information to remote computer systems.

Although the controller 700 of FIG. 7 is depicted as a general purpose computer that is programmed to perform various control functions in accordance with the present invention, the invention can be implemented in hardware, for example, as an application specified integrated circuit (ASIC). As such, the process steps described herein are intended to be broadly interpreted as being equivalently performed by software, hardware, or a combination thereof.

Although various embodiments that incorporate the teachings of the present invention have been shown and described in detail herein, those skilled in the art can readily devise many other varied embodiments that still incorporate these teachings.

We claim:

1. A method comprising:
using at least one light sensor array to gather information regarding an item;
determining said item's location, on a conveyor, from said information and a speed of said conveyor;
switching to a radio frequency identification (“RFID”) reader antenna in a plurality of RFID reader antennas in accordance with said item location.

2. The method of claim 1 wherein said at least one light sensor array comprises at least one light sensor operating at a frequency range of about 380 nano-meters to about 780 nano-meters.

3. The method of 1 wherein said at least one light sensor array comprises at least one of a one light sensor operating at a first frequency range visible to a human eye and a second frequency range not visible to said human eye.

4. The method of claim 1 wherein said plurality of RFID antennas is strategically positioned with said conveyor.

5. The method of claim 1 wherein said at least one light sensor array is strategically positioned with said conveyor.

6. The method of claim 1 wherein said at least one light sensor array is substantially traverse to and above said conveyor.

7. The method of claim 1 wherein said at least one light sensor array is substantially perpendicular to said conveyor.

8. The method of claim 1 wherein each antenna in said plurality of RFID reader antennas has at least one of a different interrogation area and operating frequency.

9. The method of claim 1 wherein said information comprises at least one of a detection of said item and peripheral information of said item.

10. A method comprising:
using at least one light sensor array to detect an item on a conveyor; and
activating a radio frequency identification (“RFID”) antenna in accordance with said detection.

11. The method of claim 10 wherein said at least one light sensor array comprises at least one of a one light sensor operating at a first frequency range visible to a human eye and a second frequency range not visible to said human eye.

12. The method of claim 10 wherein said at least one light sensor array comprises at least one light sensor operating at a frequency range of about 380 nano-meters to about 780 nano-meters.

13. The method of claim 10 wherein said at least one light sensor array gathers peripheral information for said item.

14. The method of claim 13 wherein said peripheral information comprises at least one of a detection of said item and peripheral information of said item.

15. A computer-readable medium having stored thereon a plurality of instructions, the plurality of instructions including instructions which, when executed by a processor, cause the processor to perform the steps comprising:
using at least one light sensor array to provide peripheral information of an item;
determining a location of said item, on a conveyor, from said peripheral information and a speed of said conveyor;
switching to a radio frequency identification (“RFID”) reader antenna in a plurality of RFID reader antennas in accordance with said item location.

16. The computer-readable medium of claim 15 wherein said at least one light sensor operating at a frequency range of about 380 nano-meters to about 780 nano-meters.

17. The computer-readable medium of claim 15 wherein said at least one light sensor array comprises at least one of a one light sensor operating at a first frequency range visible to a human eye and a second frequency range not visible to said human eye.

18. The computer-readable medium of claim 15 wherein said plurality of RFID antennas is strategically positioned with said conveyor.

19. The computer-readable medium of claim 15 wherein said at least one light sensor array is strategically positioned with said conveyor.

20. The computer-readable medium of claim 15 wherein said at least one light sensor array is substantially traverse to and above said conveyor.

21. Apparatus comprising:
an input adapted to receive an item's peripheral information;
a processor adapted to derive a location of said item from said peripheral information and a speed of a conveyor, and to determine, from said location, an appropriate radio frequency identification (“RFID”) reader antenna in a plurality of RFID antennas; and
an output adapted to transmit an instruction to switch to said appropriate antenna.

22. The apparatus of claim 21 wherein said input receives said peripheral information from a plurality of light sensors.

23. The apparatus of claim 21 further comprising an antenna switch adapted to receive said output and to switch to said appropriate antenna.

24. The apparatus of claim 21 further comprising a memory for storing at least one of operating frequencies, interrogation areas, and positions of each RFID antenna in said plurality of RFID antennas.

25. A system comprising:
a conveyor subsystem;
at least one light sensor array calibrated with said conveyor subsystem;
a tachometer coupled to said conveyor subsystem; and
a processor coupled to said tachometer and said at least one light sensor array.

26. The system of claim 25 wherein said at least one light sensor array transmits peripheral information towards said processor; and
said tachometer transmits conveyor speed towards said processor.

27. The system of claim 26 wherein said processor performs steps comprising:
determining, from said peripheral information and said conveyor speed, an appropriate radio frequency identification (“RFID”) reader antenna in a plurality of RFID antennas.

28. The system of claim 25 wherein said at least one light sensor array comprises at least one of a one light sensor operating at a first frequency range visible to a human eye and a second frequency range not visible to said human eye.

29. The system of claim 25 wherein said at least one light sensor array comprises at least one light sensor operating at a frequency range of about 380 nano-meters to about 780 nano-meters.
